(19) United States
(12) Patent Application Publication
(10) Pub. No.: US 2026/0024389 A1
(43) Pub. Date: Jan. 22, 2026

(54) ELECTRONIC LOCK WITH AN ACTUATION AND CASCADE SELF-POWERING EMBEDDED MECHATRONIC SYSTEM

(71) Applicant: OJMAR, S.A., Elgoibar (ES)

(72) Inventors: Mikel Solozabal Ibarra, Zumaia (ES); Álvaro Valtierra de Pablo, Berango (ES); Jon Zabala Zabaleta, Eibar (ES)

(73) Assignee: OJMAR, S.A., Elgoibar (ES)

(21) Appl. No.: 19/340,121

(22) Filed: Sep. 25, 2025

(30) Foreign Application Priority Data
Feb. 21, 2024 (ES) P202430126
Sep. 25, 2024 (WO) PCT/ES2024/070587

(51) Int. Cl. G07C 9/00

(52) U.S. Cl. CPC G07C 9/00309; G07C 2009/0065; G07C 2009/00769; G07C 2209/08; G07C 2209/61

(57) ABSTRACT

Electronic lock with an actuation and cascade self-powering embedded mechatronic system (1) comprising an electric generator (2) that generates electrical energy of variable voltage from a minimum voltage to a maximum voltage from mechanical energy and is capable of communicating through the lock starter chip (3) with a near field, energizing and storing the identification data (4b) provided by the near field (4) in the local memory (3a) of the lock starter chip (3), allowing it to be recovered in a specific time through the energy generated by the electric generator (2).

### PRIORITY CLAIM

This application claims priority to International Patent Application No. PCT/ES2024/070587 filed Sep. 25, 2024, which application claims priority to Spanish Patent Application No. P202430126 filed Feb. 21, 2024, which applications are incorporated herein by reference in their entirety.

### FIELD OF THE INVENTION

This present technology concerns an electronic lock with an actuation and cascade self-powering embedded mechatronic system, which is used to close cabinets, drawers, and other furniture such as gym lockers, with communication and energy supply capacity through a near field.

Prior state of the art Electronic locks for closing furniture are known currently and as a reference to the state of the art. Battery-powered locks and even locks with rechargeable batteries that recharge using electric generators (dynamic mechanical generators, solar panels, etc.) are also known.

Electric generators, depending on the type and mode of activation, produce variable voltage energy from a minimum voltage to a maximum voltage. Systems and methods for simultaneous generation and consumption are known that take advantage of the electrical energy generated through the sequential activation of the elements that make up the lock depending on the energy and time they require, which need to be activated so that when the energy generated is small (for example at the beginning of activation), the elements requiring little voltage are activated and when the energy generated is high (peak of activation), the elements requiring a lot of voltage are activated. However, to carry out the action quickly, these methods require maintenance or energy accumulators, which have a great environmental impact. This is because applying the method requires them to first “wake up” or activate the lock to decide which element to activate and this requires minimal initial energy, which is why additional batteries or accumulators are required in these systems.

Currently, electronic locks have a wide range of data entry possibilities (NFC, RFID, keyboard, online applications, etc.), with the same lock often combining several possibilities. This combination means that the lock must be active continuously (searching for signals), leading to high energy consumption and making it necessary to add batteries or energy accumulators that limit the lock's ideal renewable energy and energy self-powering.

### SUMMARY

Confronted with this state of affairs, the present technology refers to an electronic lock with an actuation and cascade self-powering embedded mechatronic system. The mechatronic system comprises an electric generator that generates electrical energy of variable voltage from a minimum voltage to a maximum voltage from mechanical energy, allowing all the elements that make up the lock to be sequentially activated, making the most of the electrical energy generated. It is also capable of receiving energy from the near field for the inclusion of identification data in a starter chip and communicating through the lock starter chip to receive and store the identification data provided by the near field in the local memory of the lock starter chip. This storage allows the identification data to be recovered from the local memory by the lock for a specific time, through a cascade activation system with the energy subsequently generated by the electric generator when mechanical energy is applied.

The lock's starter chip, deprived of power and with no signal searching, is turned off until a power source comes near, such as a near field, which activates or awakens the starter chip upon entering into communication with it. This allows data to be inserted into it, such as: identification data, e.g., the data that identifies a user; event data, e.g., the data that defines the history of operations performed by the lock (who has given instructions to the lock, when or the type of instructions: opening, closing, etc.) or system data, e.g., the data necessary for the operation of the system such as software updates, new authorized users, permissions, etc.

This near field can be communicated through near field communication (NFC) or radiofrequency identification (RFID) among other means and can be constituted by a photovoltaic environmental energy source such as a solar panel or an electromagnetic source such as NFC or RFID.

The lock described here comprises an electric generator that generates electrical energy of variable voltage from a minimum voltage to a maximum voltage from mechanical energy, the application of this mechanical energy being necessary, either in the form of pulsating, rotating, or any other application mode so that the electric generator provides the necessary electrical energy in a second moment for the recovery of the identification data provided by the near field inserted in the local memory of the starter chip for comparison with the lock's identification data.

The actuation and cascade self-powering of the lock refers to the sequence of actuation of the elements that make up the lock. Given the variability of the voltage generated by the electric generator that comprises the lock, this sequence is based on establishing the order of action of the components in order to make the most of the energy generated. To do this, as soon as energy begins to be generated in the electric generator, a voltage regulator, which is activated with minimal energy, communicates to the lock's microcontroller that there is energy while supplying it electrically. This microcontroller, which has a very low energy requirement, the lowest after the voltage regulator, communicates through data lines with the rest of the lock's mechatronic components. The microcontroller is pre-programmed with the activation sequence of the components that need power based on each component's minimum activation voltage and activation time interval. The activation sequence begins with the components requiring the lowest activation voltages and ends with those requiring the highest activation voltages, prioritizing the element with the longest activation time interval in case of equal activation voltage. Following the programmed activation sequence, the microcontroller sequentially activates the lock components, in cascade, intelligently managing the use of the electrical energy generated by the electric generator.

The use of energy transmission through a power source, such as a near field, allows the energy emitter to actively search for a receiver, which means that the receiver, in our case the starter chip, remains in a passive state until the energy is received. The near field can be constituted by electromagnetic radiofrequency waves that allow energy induction and data transmission such as NFC or RFID or by photovoltaic or electromagnetic energy such as a small solar panel. The starter chip, upon communicating with that near field, stores the identification data transmitted via near field in a local memory and starts a counter for a predetermined time, allowing the user, during this predetermined time, to apply mechanical energy to activate the electric generator that generates the main power of the electronic lock with the actuation and cascade self-powering embedded mechatronic system. This mechanical activation, which can be done by pulsating the knob, for example, can be done directly with a mobile phone. It is even expected that the opening of the lock could be powered simultaneously by the near field cascade self-powering in order to reduce the force required to pulsate the knob and facilitate accessibility. Once the identification data transmitted by the near field is stored, if the mechanical energy is applied within the predetermined time, the starter chip will transmit the identification data to the electronic lock with the actuation and cascade self-powering embedded mechatronic system for internal comparison with the lock's identification data. If mechanical energy is not applied within the predetermined time, the starter chip will not transmit the data, and the user will be denied access, the embedded data being erased in approximately 10 seconds, although another time can be set for this. With this previous step, if no additional identification is required (additional security lock), a very quick opening can be achieved by providing the lock with the identification data from the moment it is activated, without it needing to be requested and with the possibility of using smaller generators by eliminating the energy demand for data collection.

This configuration also enables the entry of data to be decoupled from the lock's main power supply, allowing an off state without a power supply to the lock until power is received in the starter chip. This off state allows for a truly self-powered lock, independent of (without) batteries and capacitors since it does not require the continuous search for signals by the electronic lock with an actuation and cascade self-powering embedded mechatronic system, as the starter chip remains in a passive state until energy is received from the power source or near field, which in turn communicates the identification data.

With this lock configuration, alternatively, it is expected that the insertion and storage of access data in the local memory can be powered by a solar panel located on the outside of the lock, this being another source of energy supply. Because the power required is exclusively for the insertion of identification data, this solar panel can be a very small solar cell, and even operate with interior lighting (like the solar panels arranged on a pocket calculator), which is convenient given the usual location of the furniture that requires this type of lock, such as inside changing rooms, offices or warehouses, that is, interior spaces that receive little or no natural light.

By entering the identification data together with the energizing, two-phase verification (additional security lock) is possible, increasing security, for example, entering identification data via near field NFC and, after applying mechanical energy to the electric generator with the use of an RFID access card, performing a second transmission of radiofrequency identification data. Carrying out this second transmission of identification data requires the card to be brought close to a reader, powered by the energy generated by the electric generator.

This second transmission of identification data can be carried out by any known data transmission means, such as; a keyboard, RFID, NFC, Bluetooth, BLE, etc.

The starter chip may consist of a single chip capable of receiving near field energy and also communicating through the near field. Locks configured in this manner are easier to produce, as a single chip integrates several functions (power and communication) in a single element, and they are less polluting, as they are made up of fewer polluting elements.

This starter chip may alternatively consist of a single communication chip that does not require an additional chip for additional communications (additional security lock) because it is capable of receiving communications from communication protocols (for example, NFC and RFID) and receiving the near field energy with the use of discrete electronics designed for this purpose. This allows for a lock with additional, less polluting security,

Another added advantage is that it is alternatively foreseen that the initial entry of data is not limited to identification data, since there are situations in which it is not required to open the lock, but data exchange is required, such as event data (who gave instructions to the lock, when or the type of instructions) requested by the administrator or system data such as new users, automatic opening times, system updates, etc. without it being necessary to activate the electric generator. To do this, users identify themselves by initially introducing the identification data as authorized users to consult the event data or enter data into the system and supplies, using energy from the power supply such as the near field, the transmission of event data and/or system data. Thanks to this rapid exchange, it is not necessary to apply mechanical energy to activate the electric generator every time one wishes to make a query or insert event data.

Another aspect of the present technology is the possible online functionality, which, after the identification data is entered and then recovered using the energy generated by the electric generator, allows, through a high-frequency antenna, powered by the generator, electrical, online communication with a server through a gateway. The online communication may be for the purpose of online comparison with the server's access data, identifying whether or not there is an authorized user to operate the electronic lock with an actuation and cascade self-powering embedded mechatronic system.

The authorization of a user to operate the electronic lock with an actuation and cascade self-powering embedded mechatronic system will follow the following framework: After transmission of identification data and energy to the starter chip, if mechanical energy has been applied to activate the electric generator within the period predetermined by the counter, the starter chip transmits the identification data previously saved in the local memory for data processing. If online functionality is available, the electronic lock with an actuation and cascade self-powering embedded mechatronic system checks the connection, and, if it is suitable, it sends the information received from the identification data to the server through the gateway. The server compares the identification data received with the access data of the server, identifying whether or not there is an authorized user, and responds by sending the corresponding operating instructions through the gateway to the electronic lock with an actuation and cascade self-powering embedded mechatronic system in order for it to perform the pertinent operation and send back the generated events. If online functionality is not available or the connection is not adequate even where it is available, the electronic lock with an actuation and cascade self-powering embedded mechatronic system compares the identification data with the lock identification data, determining whether the user is, or is not, authorized and performs the operations necessary to allow or deny access.

By using the online functionality, semi-automatic openings can be programmed by programming the server to send an opening order to the lock at a preset time (for example, when closing a gym), so, due to the electric generator, it would only be necessary to apply mechanical energy (for example, pulsating the knob) to energize the electronic lock with an actuation and cascade self-powering embedded mechatronic system, which receives the opening order and acts accordingly (for example by retracting a latch) to open the locker.

In addition, the online functionality allows the identification data information to be sent from the mobile phone through an online application directly to the server and this connects with the gateway, which, after identifying the user as an authorized user, sends the corresponding operating instructions to the electronic lock with an actuation and cascade self-powering embedded mechatronic system so that it performs the corresponding operation, thus allowing users to be identified remotely. For example, in the case of locks with additional security, second identification data can be sent to enable access, for example, to files that contain information requiring special permission or, if a prior online payment for the application and use of lockers is to be made, the server sends the second identification data once the payment for use has been confirmed.

Online communication also allows other data such as system data to be introduced through a high-frequency antenna after entering the identification and activation data of the electronic lock with an actuation and cascade self-powering embedded mechatronic system by applying mechanical energy to the electric generator. This online communication allows a user to receive system data directly from the server through the gateway and validate online the changes introduced (such as accrediting a new user or updating the system).

### DRAWINGS AND REFERENCES

To better understand the nature of the invention, the attached drawings depict an industrial embodiment that is merely an illustrative and non-limiting example.

FIG. 1 shows the operating diagram of the lock in which the flow of energy is observed and data entered through a near field or alternatively through a keyboard (dotted line), in which the identification data (4b) emitted through a near field (4) is entered into the lock starter chip (3) of the electronic lock with an actuation and cascade self-powering embedded mechatronic system (1), is transmitted to the local memory (3a) and the counter (3b) and the part of the process powered by an electric generator that powers the recovery of identification data (4b) from the local memory (3a), the comparison of the identification data (4b) with the lock identification data (1a) and the cascade activation system for opening or closing the electronic lock with an actuation and cascade self-powering embedded mechatronic system (1) are activated.

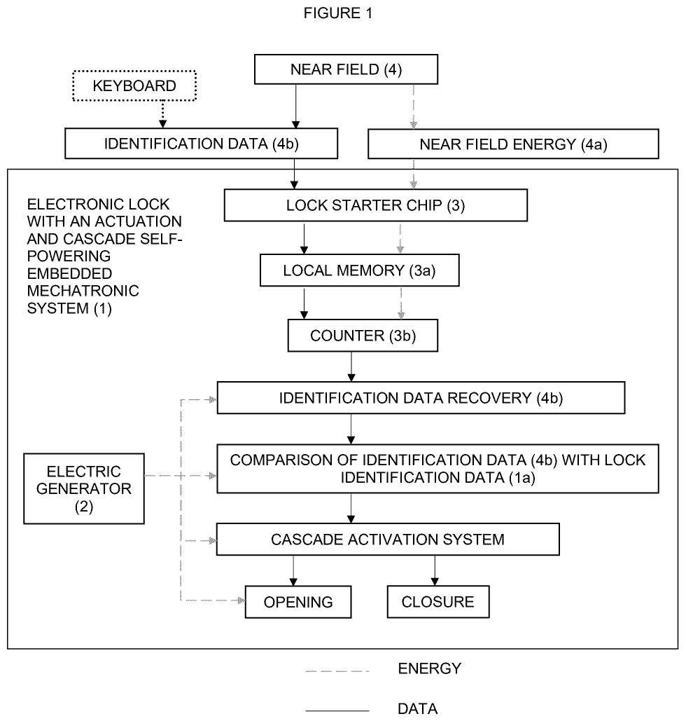

FIG. 2 shows the operating diagram of the lock with online functionality in which the identification data (4b) is transmitted, after recovery, to a server (6) through a gateway (7) for comparison with the access data (6a).

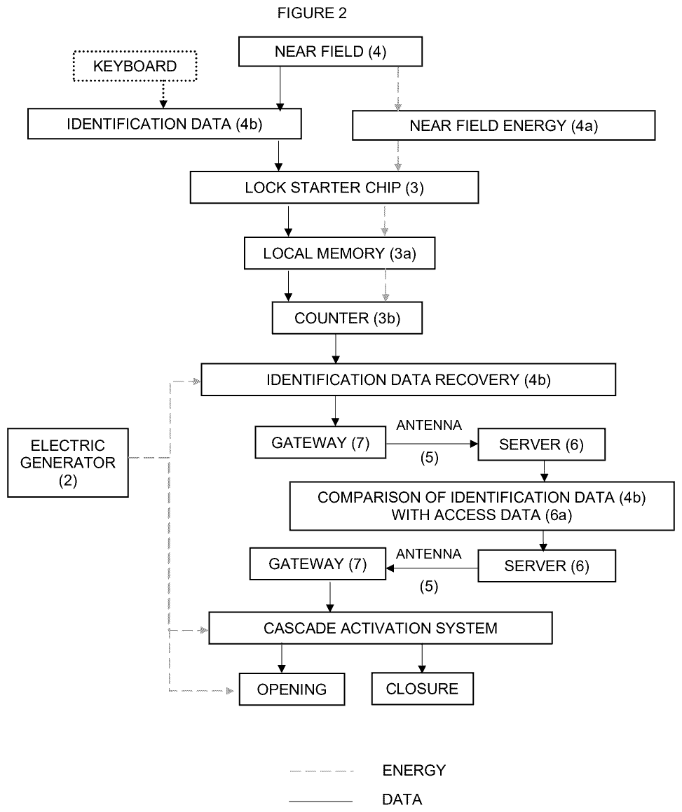

FIG. 3 shows the operating diagram of the lock with online functionality and event data communication (4c) to the server (6) through the gateway (7) after opening/closing the lock.

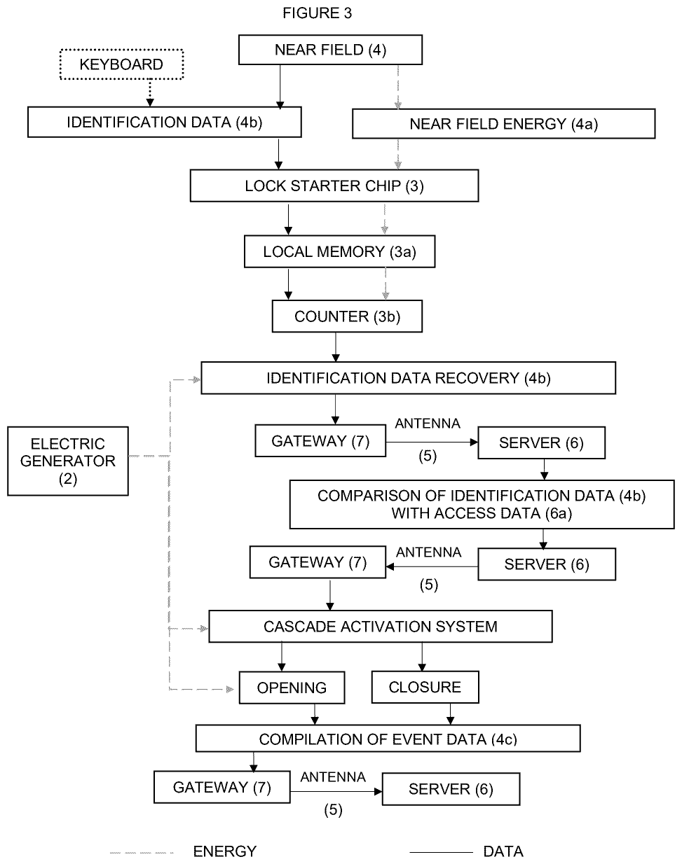

FIG. 4 shows the operating diagram of the lock with online functionality and communication of system data (4d) to a server (6) through a gateway (7) for validation with valid system data (6b).

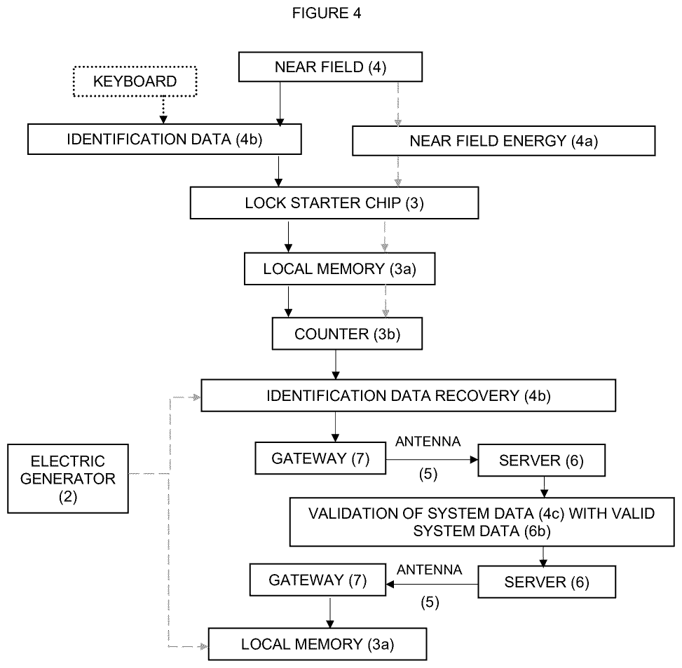

The following references are indicated in these figures:
1. Electronic lock with an actuation and cascade self-powering embedded mechatronic system
   1a. Lock identification data
2. Electric generator
3. Lock starter chip
3a. Local memory
3b. Counter
4. Near field
   4a. Near field energy
   4b. Identification data
   4c. Event data
   4d. System data
5. High-frequency antenna
6. Server
   6a. Access data
   6b. Valid system data
7. gateway

### DETAILED DESCRIPTION

In relation to the drawings and references listed above, embodiments of the present technology are illustrated in the attached drawings, referring to an electronic lock with an actuation and cascade self-powering embedded mechatronic system (1). The mechatronic system (1) comprises an electric generator (2) that generates an electrical energy of variable voltage from a minimum voltage to a maximum voltage from a mechanical energy and is capable of being energized through a near field (4) and communicating through a lock starter chip (3). The mechatronic system (1) stores the identification data (4b) provided by the near field (4) in the local memory (3a) of the lock starter chip (3), allowing its recovery during a specific time, using the energy generated by the electric generator (2).

In embodiments, when bringing a near-field generator closer to the electronic lock with an actuation and cascade self-powering embedded mechatronic system (1), such as NFC, using a mobile phone or smartwatch, a first source, or first power source, such as the generator near field, will emit energy and data to the receiver or lock starter chip (3). Through near field NFC communication (4), the identification data (4b) and the required near field energy (4a) are transmitted to the lock starter chip (3). Thus, the NFC communication of a mobile phone, smartwatch, or any device equipped with this technology can be used to energize the lock starter chip (3) and user identification. This near field energy (4a), transmitted through NFC, is only necessary for energy activation and inclusion of data in the lock starter chip (3), which stores the identification data (4b) in the local memory (3a) and starts a counter (3b) for a specific period of approximately 10 seconds, although another specific period can be established. Using a predefined time period, the impact on the battery of the device, for example, the mobile phone, will not be as high as if the entire lock were powered and responds to the problem of excessive battery demand that occurs in NFC-only power locks.

In embodiments, at some time after receipt of the identification data (4b), a user will provide mechanical energy to the lock (1) by manipulating an actuator on the lock. This mechanical energy is used to start up the electric generator (2). Upon start up, an initial (small) voltage from the generator (2) is used to retrieve identification data (1a) from a permanent memory within the lock (1). One or more processors within the lock (1) then compare the received identification data (4b) and the identification data (1a) retrieved from permanent memory. In embodiments, the mechanical energy used to start the electric generator must be received within the present period of time as measured by the counter (3b). If not, the lock will not operate. The lock will also not operate if the received and retrieved identification data do not match upon comparison by the one or more processors.

Although the mechanical energy may be received sometime after the received identification data (4b), it is also foreseen that the two feeding modes; near field energy (4a), which may be electromagnetic energy, such as NFC or photovoltaic energy such as solar energy through a solar panel, and the energy obtained from a second source such as mechanical energy (for example pulsating, pressing, pulling, or rotating a knob or similar) to power the electrical generator may act simultaneously, once the identification data (4b) is incorporated into the lock starter chip (3) through the near field (4). Moreover, while embodiments are described where the near field energy (4a) powers a first set of one or more functions, and the mechanical energy from actuating the lock powers a second set of one or more functions, it is understood that the near field energy and/or the mechanical energy may power additional and/or alternative functions in further embodiments, and may share the totality of functions differently in further embodiments.

The user has a certain time set by the counter (3b) of the lock starter chip (3), which may be approximately 10 seconds, to apply the mechanical energy necessary to activate the electric generator (2) and generate the main energy of the electronic lock with an actuation and cascade self-powering embedded mechatronic system (1). Preferably the mechanical energy applied will be in the form of pulsating. However, it is understood that this mechanical energy may be applied by pressing, pulling, rotating, etc. any of various mechanical actuators on the mechatronic system (1).

This configuration allows for a truly self-powered electronic lock with an actuation and cascade self-powering embedded mechatronic system (1). “Self-powered” as used herein refers to the fact that the lock operates independent of (without) batteries and capacitors since the introduction of identification data (4b) is independent of the main power supply of the electronic lock with an actuation and cascade self-powering embedded mechatronic system (1) that is produced by the electric generator (2) and does not require energy until it receives energy, transmitted through near field (4) NFC or an alternative power source such as a solar panel, in the lock starter chip (3).

With the energy generated by the electric generator (2), the electronic lock with an actuation and cascade self-powering embedded mechatronic system (1) distributes the energy following cascade guidelines where a voltage regulator, which is activated with minimal energy, communicates to the lock's microcontroller that there is power while feeding it electrically. This microcontroller has a very low energy requirement, the lowest after the voltage regulator, and communicates through data lines with the rest of the lock's mechatronic components. The microcontroller is pre-programmed with the activation sequence of the components that require power based on the minimum activation voltage and the activation time interval of each component. The activation sequence begins with the components that require the lowest activation voltages and ends with those that require the highest, prioritizing the element with the longest activation time interval in case of equal activation voltage. Following the programmed activation sequence, the microcontroller, in cascade, sequentially activates the lock's components, intelligently managing the use of the electrical energy generated by the electric generator (2) until each element that makes up the electronic lock with an actuation and cascade self-feeding embedded mechatronic system (1) is activated. With the received energy, it recovers the identification data (4b) from the local memory (3a) of the lock starter chip (3) and compares the identification data (4b) received through the near field (4) with the lock identification data (1a) to accredit, or not, the user as an authorized user and sends the pertinent instruction (opening, closing) to the electronic lock with an actuation and cascade self-powering embedded mechatronic system (1). This configuration allows for an electronic lock with an actuation and cascade self-powering embedded mechatronic system (1) without the need to store energy in an accumulator for the initial entry of identification data (4b), which is, therefore, free of batteries and accumulators.

Another embodiment of the invention allows identification data to be verified (4b) in two phases, increasing security through the introduction and initial energization of identification data (4b) using a near field (4). This alternative embodiment, after activating the electric generator (2), enables, for example, the use of an RFID access card with its consequent reading of card data containing the second identification data (4b), thus increasing the security of the electronic lock with an actuation and cascade self-powering embedded mechatronic system (1) as two pieces of identification data (4b) are required to authorize access to the lock.

Variants of the present technology allow the energization of the storage for the initial insertion of identification data (4b) in the local memory (3a) of the lock starter chip (3) and start a counter (3b) using different means of generating energy or power sources, such as a solar panel located on the outside of the lock or other means in combination with identification data entry means (4b), such as a keyboard. Because the energy required is only that necessary to power the identification data entry (4b), this solar panel can be small in size and even operate with interior lighting, which is convenient given that the usual location of this type of lock is in interior spaces with little or no natural lighting (in this case, it would be possible to store the mobile phone, etc. (near field generator (4)) inside the furniture, since they would not be necessary to energize the lock starter chip (3)).

There are situations that do not require the opening of the electronic lock with an actuation and cascade self-powering embedded mechatronic system (1), but the exchange of data with the electronic lock with an actuation and cascade self-powering embedded mechatronic system (1), such as event data (4c) (who and when operated the lock and details of the operation carried out) requested by the authorized administrator or system data (4d) such as the introduction of authorizations for new users, automatic opening hours, system updates, etc. without it being necessary to activate the electric generator (2). For these cases, along with the introduction of identification data (4b) that, after comparison with the lock data (1a), accredits the user as suitable to carry out the action, additional data can be transmitted using a near field (4) such as event data (4c) and/or system data (4d). Likewise, it is planned that, in the event that it is necessary to transmit a lot of data, such as user lists, the electronic lock with an actuation and cascade self-powering embedded mechatronic system (1) communicates online through a high-frequency antenna (5), powered by the energy transmitted through a near field (4), with a server (6) through a gateway (7).

Another embodiment of the present technology uses a high-frequency antenna (5), powered by the electrical energy generated by the electric generator (2), to communicate online with a server (6) through a gateway (7) for decision-making management, the electronic lock with an actuation and cascade self-powering embedded mechatronic system (1) receiving the actuation instructions from the server (6) through the gateway (7). In this embodiment with online functionality, after applying the mechanical pulsation energy to the electric generator (2), first, it is checked that there is a connection, and, if the connection is adequate, the information received from the identification data (4b) (and the second identification data (4b) from double verification using an RFID card, if this functionality is available) is sent to the server (6) through the gateway (7). The server compares this identification data (4b) with the access data (6a) found on the server (6), accredits, or not, the user as an authorized user, makes the programmed decision and sends the operating instructions to the electronic lock with an actuation and cascade self-powering embedded mechatronic system (1) (opening, closing, denial, etc.) that performs the instructed operation and then communicates the event data (4c) to the server (6). If the online connection were not adequate, a local comparison would be carried out in the electronic lock with an actuation and cascade self-powering embedded mechatronic system (1), comparing the identification data (4b) with the lock identification data (1a) as if it did not have this online functionality, and it would save the data in the local memory (3a) pending the communication of the event data (4c) when making a subsequent appropriate connection.

With the online functionality, it is possible to program automatic openings (for example, in gyms when closing), so it would only be necessary to activate the electric generator (2) (pulsate the knob) to open the electronic lock with an actuation and cascade self-powering embedded mechatronic system (1) (powered with the energy generated by the electric generator (2)), since the electronic lock with an actuation and cascade self-powering embedded mechatronic system (1) can receive, from a certain time, the opening pre-programmed instruction.

In addition, this online functionality allows the identification data information (4b) to be sent from the mobile phone through an online application directly to the server (6) and this connects with the gateway (7) to send the operating instructions to the electronic lock with an actuation and cascade self-powering embedded mechatronic system (1), thus allowing remote double identification of users, or prior online payment for the use of lockers thanks to the sending of the identification data (4b) by the server (6) after payment confirmation is received and even sending an automatic opening instruction to the electronic lock with an actuation and cascade self-powering embedded mechatronic system (1), if the paid time is exceeded.

Online communication also allows other data to be introduced such as system data (4d), for example, scheduled updates, although in this case, it would be necessary to activate the electric generator (2) of the electronic lock with an actuation and cascade self-powering embedded mechatronic system (1) by applying mechanical energy. This feature is convenient if you want to transmit a large amount of system data (4c), since it does not depend on the energy generated by near field (4) NFC.
A. In embodiments, the present technology relates to an electronic lock comprising: a mechatronic system configured to receive identification data upon receipt of a first energizing signal from a first source, retrieving stored identification data from memory resident within the mechatronic system upon receipt of a second energizing signal from a second source, different from the first source, comparing the received and retrieved identification data, and operating the electronic lock if the received and retrieved identification data match,
B. The electronic lock of paragraph A, wherein the lock will only operate if the retrieved identification data is received within a preset period of time of the received identification data.
C. The electronic lock of paragraph A, wherein the first source transmits the first energizing signal by radio frequency.
D. The electronic lock of paragraph A, wherein the first source transmits the identification data by radio frequency.
E. The electronic lock of paragraph A, wherein the first source transmits the first energizing signal by near field communication.
F. The electronic lock of paragraph A, wherein the first source transmits the identification data by near field communication.
G. The electronic lock of paragraph A, wherein the first source transmits the first energizing signal by solar energy.
H. The electronic lock of paragraph A, wherein the second source comprises an electric generator within the electronic lock, and the lock further comprising a manual actuator, the generator providing the second energizing signal upon receipt of energy from the manual actuator.
I. The electronic lock of paragraph H, wherein the electric generator generates electrical energy of variable voltage from a minimum voltage to a maximum voltage from the mechanical actuator, different voltages from the electric generator used to energize different components of the electronic lock.
J. The electronic lock of paragraph A, further comprising a counter, energized by the first energizing signal, for counting down the present period of time.
K. In embodiments, the present technology relates to a self-powered electronic lock comprising: a mechatronic system configured to receive identification data upon receipt of a first energizing signal from a first source, retrieving stored identification data from memory resident within the mechatronic system upon receipt of a second energizing signal from a second, mechanical force source, different from the first source, comparing the received and retrieved identification data, and operating the electronic lock if the received and retrieved identification data match,
L. The electronic lock of paragraph K, wherein the lock will only operate if the retrieved identification data is received within a preset period of time of the received identification data.
M. The electronic lock of paragraph K, wherein the first source transmits the first energizing signal by radio frequency.
N. The electronic lock of paragraph K, wherein the first source transmits the identification data by radio frequency.
O. The electronic lock of paragraph K, wherein the first source transmits the first energizing signal by near field communication.
P. The electronic lock of paragraph K, wherein the first source transmits the identification data by near field communication.
Q. The electronic lock of paragraph K, wherein the first source transmits the first energizing signal by solar energy.
R. The electronic lock of paragraph K, wherein the second, mechanical source comprises an electric generator within the electronic lock, and the lock further comprising a manual actuator, the generator providing the second energizing signal upon receipt of mechanical energy from the manual actuator.
S. The electronic lock of paragraph R, wherein the electric generator generates electrical energy of variable voltage from a minimum voltage to a maximum voltage from the mechanical actuator, different voltages from the electric generator used to energize different components of the electronic lock.
T. Embodiments of the present technology further relate to an electronic lock comprising: a mechatronic system and an electric generator, the mechatronic system configured to receive identification data upon receipt of a first energizing signal using near field communication, retrieving stored identification data upon receipt of a second energizing signal from the electric generator, comparing the received and retrieved identification data, and operating the electronic lock if the received and retrieved identification data match
U. The electronic lock of paragraph T, wherein further the lock only operates if the retrieved identification data is retrieved within a preset period of time of the received identification data.
V. The electronic lock of paragraph U, the lock further comprising a manual actuator, the generator providing the second energizing signal upon receipt of energy from the manual actuator.
W. The electronic lock of paragraph U, further comprising a counter, energized by the first energizing signal, for counting down the present period of time.
X. In further embodiments, the present technology relates an electronic lock comprising: a mechatronic system configured to receive identification data upon receipt of a first energizing signal from a first source, the mechatronic system further configured to receive stored identification data from memory resident within a remote server upon receipt of a second energizing signal from a second source, different from the first source, comparing the received identification data from the first source and the stored identification data from the remote server, and operating the electronic lock if the received identification data from the first source and the stored identification data from the remote server match.
Y. The electronic lock of paragraph X, wherein the mechatronic system is further configured to receive system updates from the server upon successful matching of the received identification data from the first source and the stored identification data from the remote server.
Z. The electronic lock of paragraph X, wherein the mechatronic system is further configured to exchange data with the server upon successful matching of the received identification data from the first source and the stored identification data from the remote server.
AA. The electronic lock of paragraph X, wherein the first source transmits the first energizing signal by radio frequency.
BB. The electronic lock of paragraph X, wherein the first source transmits the identification data by radio frequency.
CC. The electronic lock of paragraph X, wherein the first source transmits the first energizing signal by near field communication.
DD. The electronic lock of paragraph X, wherein the first source transmits the identification data by near field communication.
EE. The electronic lock of paragraph X, wherein the first source transmits the first energizing signal by solar energy.
FF. The electronic lock of paragraph X, wherein the second source comprises an electric generator within the electronic lock, and the lock further comprising a manual actuator, the generator providing the second energizing signal upon receipt of energy from the manual actuator.
GG. The electronic lock of paragraph X, wherein the second energizing signal from the second source must be received within a predetermined period of time of receipt of the first energizing signal from the first source for the lock to open.
Variations in materials, shape, size, and arrangement of the component elements, described in a non-limiting manner, do not alter the essence of this invention, this description being sufficient to proceed with its reproduction by an expert.

We claim:

1. An electronic lock comprising:
a mechatronic system configured to:
receive identification data upon receipt of a first energizing signal from a first source,
retrieve stored identification data from memory resident within the mechatronic system upon receipt of a second energizing signal from a second source, different from the first source,
compare the received and retrieved identification data, and
operate the electronic lock if the received and retrieved identification data match.

2. The electronic lock of claim 1, wherein the lock will only operate if the retrieved identification data is received within a preset period of time of the received identification data.

3. The electronic lock of claim 1, wherein the first source transmits the first energizing signal by radio frequency.

4. The electronic lock of claim 1, wherein the first source transmits the identification data by radio frequency.

5. The electronic lock of claim 1, wherein the first source transmits the first energizing signal by near field communication.

6. The electronic lock of claim 1, wherein the first source transmits the identification data by near field communication.

7. The electronic lock of claim 1, wherein the first source transmits the first energizing signal by solar energy.

8. The electronic lock of claim 1, wherein the second source comprises an electric generator within the electronic lock, and the lock further comprising a manual actuator, the generator providing the second energizing signal upon receipt of energy from the manual actuator.

9. The electronic lock of claim 8, wherein the electric generator generates electrical energy of variable voltage from a minimum voltage to a maximum voltage from the mechanical actuator, different voltages from the electric generator used to energize different components of the electronic lock.

10. The electronic lock of claim 1, further comprising a counter, energized by the first energizing signal, for counting down the present period of time.

11. An electronic lock comprising:
a mechatronic system and an electric generator, the mechatronic system configured to:
receive identification data upon receipt of a first energizing signal using near field communication,
retrieve stored identification data upon receipt of a second energizing signal from the electric generator,
compare the received and retrieved identification data, and
operate the electronic lock if the received and retrieved identification data match.

12. The electronic lock of claim 11, wherein further the lock only operates if the retrieved identification data is retrieved within a preset period of time of the received identification data.

13. The electronic lock of claim 12, the lock further comprising a manual actuator, the generator providing the second energizing signal upon receipt of energy from the manual actuator.

14. The electronic lock of claim 12, further comprising a counter, energized by the first energizing signal, for counting down the present period of time.

15. An electronic lock comprising:
a mechatronic system configured to receive identification data upon receipt of a first energizing signal from a first source,
the mechatronic system further configured to:
receive stored identification data from memory resident within a remote server upon receipt of a second energizing signal from a second source, different from the first source,
compare the received identification data from the first source and the stored identification data from the remote server, and
operate the electronic lock if the received identification data from the first source and the stored identification data from the remote server match.

16. The electronic lock of claim 15, wherein the mechatronic system is further configured to receive system updates from the server upon successful matching of the received identification data from the first source and the stored identification data from the remote server.

17. The electronic lock of claim 15, wherein the mechatronic system is further configured to exchange data with the server upon successful matching of the received identification data from the first source and the stored identification data from the remote server.

18. The electronic lock of claim 15, wherein the first source transmits the first energizing signal by radio frequency.

19. The electronic lock of claim 15, wherein the first source transmits the identification data by radio frequency.

20. The electronic lock of claim 15, wherein the first source transmits the first energizing signal by near field communication.

21. The electronic lock of claim 15, wherein the first source transmits the identification data by near field communication.

22. The electronic lock of claim 15, wherein the first source transmits the first energizing signal by solar energy.

23. The electronic lock of claim 15, wherein the second source comprises an electric generator within the electronic lock, and the lock further comprising a manual actuator, the generator providing the second energizing signal upon receipt of energy from the manual actuator.

24. The electronic lock of claim 15, wherein the second energizing signal from the second source must be received within a predetermined period of time of receipt of the first energizing signal from the first source for the lock to open.
